(19) United States
(12) Patent Application Publication
(10) Pub. No.: US 2020/0257014 A1
(43) Pub. Date: Aug. 13, 2020

(54) Using Magnetism To Evaluate Tubing String Integrity In A Wellbore With Multiple Tubing Strings

(71) Applicant: Hailiburton Energy Services, Inc., Houston, TX (US)

(72) Inventors: Reza Khalaj Amineh, Houston, TX (US); Burkay Donderici, Pittsford, NY (US); Luis San Martin, Houston, TX (US)

(21) Appl. No.: 15/774,202

(22) PCT Filed: Jun. 29, 2017
(86) PCT No.: PCT/US2017/039868

§ 371 Date: May 7, 2018

(51) Int. Cl. G01V 3/28; E21B 47/00; E21B 47/007

(52) U.S. Cl. CPC G01V 3/28; E21B 47/007; E21B 47/006

(57) ABSTRACT

A tool, method, and system for evaluating integrity of one or more tubing strings in a wellbore with multiple tubing strings. The tool, method, and system may include a magnetic source that can radiate the tubing strings with at least one primary electromagnetic field, a sensor that can detect a secondary magnetic field produced by induced eddy currents in the tubing strings, and a magnetizer that can magnetize a portion of an inner-most tubing string in the wellbore such that the portion of the inner-most tubing string has an increased magnetic transparency to the primary and secondary fields when the magnetizer is enabled, where the magnetizer can include a static magnetic source, and a structure that magnetically couples the static magnetic source to the inner-most tubing string.

### TECHNICAL FIELD

The present disclosure generally relates to oilfield equipment and, in particular, to downhole tools, drilling and related systems and techniques for evaluating integrity of tubing strings in a multi-string configuration. More particularly still, the present disclosure relates to methods and systems for evaluating integrity of tubing strings in a multi-string configuration by creating an electromagnetic field within an inner tubing string, inducing eddy currents in the multiple tubing strings, measuring a secondary magnetic field produced by the eddy currents in the tubing string(s), and determining integrity of the tubing strings based on the secondary magnetic field measurements.

### BACKGROUND

A casing string is generally a tubing string that is set inside a drilled wellbore to protect and support production of fluids to the surface. In addition to providing stabilization and keeping the sides of the wellbore from caving in on themselves, the casing string can protect fluid production from outside contaminants, such as separating any fresh water reservoirs from fluids being produced through the casing. Also known as setting pipe, casing a wellbore includes running pipe (such as steel pipe) down an inside of the recently drilled portion of the wellbore. The small space between the casing and the untreated sides of the wellbore (generally referred to as an annulus) can be filled with cement to permanently set the casing in place. Casing pipe can be run from a floor of a rig, connected one joint at a time, and stabbed into a casing string that was previously inserted into the wellbore. The casing is landed when the weight of the casing string is transferred to casing hangers which are positioned proximate the top of the new casing, and can use slips or threads to suspend the new casing in the wellbore. A cement slurry can then be pumped into the wellbore and allowed to harden to permanently fix the casing in place. After the cement has hardened, the bottom of the wellbore can be drilled out, and the completion process continued.

Sometimes the wellbore is drilled in stages. Here, a wellbore is drilled to a certain depth, cased and cemented, and then the wellbore is drilled to a deeper depth, cased and cemented again, and so on. Each time the wellbore is cased, a smaller diameter casing is used. This can result in a wellbore with multiple casing strings coaxially positioned within each other. Other tubing strings, such as production strings, can also be installed in the wellbore, except the production strings may not be cemented in place like the casing strings. Over the life of the wellbore, the wellbore environment can erode, corrode, or otherwise degrade the tubing strings. Accordingly, it can be desirable to periodically check the integrity of the tubing strings (e.g. casing strings, productions strings, etc.) to ensure degradation has not damaged any of the tubing strings to a point of failure or impending failure. Therefore, it will be readily appreciated that improvements in the arts of determining tubing integrity in wellbores with multiple tubing strings are continually needed.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements. Embodiments are described in detail hereinafter with reference to the accompanying figures, in which:

FIG. 1 is a representative partial cross-sectional view of a system for capturing subsurface measurement data in a logging operation in a wellbore with multiple tubing strings, according to one or more example embodiments;

FIG. 2 is a representative partial cross-sectional view of a portion of the multiple-tubing string wellbore with a logging tool extended into the wellbore on a conveyance;

FIG. 3 is a plot of magnetic flux density and field strength for a magnetic hysteresis loop;

FIG. 4 is a representative partial cross-sectional view of the multiple-tubing string wellbore with another example logging tool that magnetically interrogates multiple tubing strings in the wellbore without using a magnetizer;

FIG. 5 is a representative partial cross-sectional view of the multiple-tubing string wellbore with another example logging tool that magnetically interrogates multiple tubing strings in the wellbore with using the magnetizer;

FIG. 6 is a representative partial cross-sectional view of the multiple-tubing string wellbore with an example magnetizer;

FIG. 7 is a representative partial cross-sectional view of the multiple-tubing string wellbore with another example magnetizer;

FIG. 8 is a representative partial cross-sectional view of the multiple-tubing string wellbore with yet another example magnetizer;

FIG. 9 is a plot of magnetic flux density and field strength for a magnetic hysteresis loop and an interrogating primary electromagnetic field above the saturation point;

FIG. 10 is a representative flow diagram of a conventional method for magnetically evaluating the integrity of multiple tubing strings in the wellbore;

FIG. 11 is a representative flow diagram of an improved method for magnetically evaluating the integrity of multiple tubing strings in the wellbore;

FIG. 12 is a representative flow diagram of the improved method for magnetically evaluating the integrity of multiple tubing strings in the wellbore, where the method simultaneously characterizes the tubing strings based on acquired data;

FIG. 13 is a representative flow diagram of the improved method for magnetically evaluating the integrity of multiple tubing strings in the wellbore, where the method sequentially characterizes the tubing strings based on acquired data;

### DETAILED DESCRIPTION OF THE DISCLOSURE

The disclosure may repeat reference numerals and/or letters in the various examples or Figures. This repetition is for the purpose of simplicity and clarity and does not in itself dictate a relationship between the various embodiments and/or configurations discussed. Further, spatially relative terms, such as beneath, below, lower, above, upper, uphole, downhole, upstream, downstream, and the like, may be used herein for ease of description to describe one element or feature's relationship to another element(s) or feature(s) as illustrated, the upward direction being toward the top of the corresponding figure and the downward direction being toward the bottom of the corresponding figure, the uphole direction being toward the surface of the wellbore, the downhole direction being toward the toe of the wellbore. Unless otherwise stated, the spatially relative terms are intended to encompass different orientations of the apparatus in use or operation in addition to the orientation depicted in the Figures. For example, if an apparatus in the Figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

Moreover even though a Figure may depict a horizontal wellbore or a vertical wellbore, unless indicated otherwise, it should be understood by those skilled in the art that the apparatus according to the present disclosure is equally well suited for use in wellbores having other orientations including vertical wellbores, slanted wellbores, multilateral wellbores or the like. Likewise, unless otherwise noted, even though a Figure may depict an onshore operation, it should be understood by those skilled in the art that the method and/or system according to the present disclosure is equally well suited for use in offshore operations and vice-versa.

As used herein, the words “comprise,” “have,” “include,” and all grammatical variations thereof are each intended to have an open, non-limiting meaning that does not exclude additional elements or steps. While compositions and methods are described in terms of “comprising,” “containing,” or “including” various components or steps, the compositions and methods also can “consist essentially of” or “consist of” the various components and steps. It should also be understood that, as used herein, “first,” “second,” and “third,” are assigned arbitrarily and are merely intended to differentiate between two or more objects, etc., as the case may be, and does not indicate any sequence. Furthermore, it is to be understood that the mere use of the word “first” does not require that there be any “second,” and the mere use of the word “second” does not require that there be any “first” or “third,” etc.

The terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

Generally, this disclosure provides a tool, method, and system for evaluating integrity of one or more tubing strings in a wellbore with multiple tubing strings. The tool, method, and system may include a magnetic source that can radiate the tubing strings with at least one primary electromagnetic field, a sensor that can detect a secondary magnetic field produced by induced eddy currents in the tubing strings, and a magnetizer that can magnetize a portion of an inner-most tubing string in the wellbore such that the portion of the inner-most tubing string has an increased magnetic transparency to the primary and secondary magnetic fields when the magnetizer is enabled. The magnetizer can include a static magnetic source and a structure that magnetically couples the static magnetic source to the inner-most tubing string. An inversion algorithm can be applied to data collected from the sensor to characterize the integrity of one or more of the tubing strings in the wellbore.

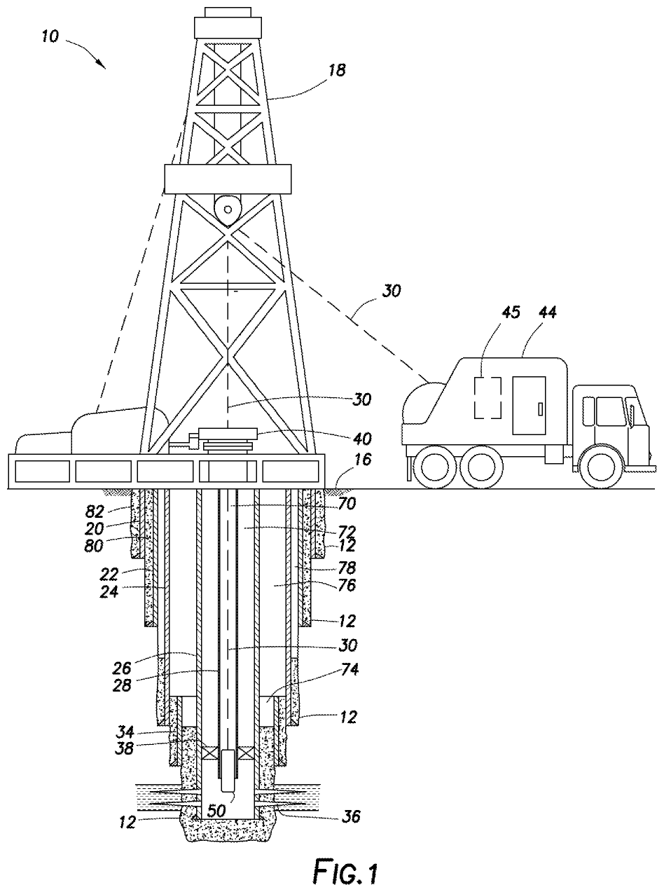

FIG. 1 shows an elevation view in partial cross-section of a wellbore system 10 which can be utilized for wireline and slickline operations in a wellbore 12. Wellbore 12 can extend through various earth strata in an oil and gas formation 14 located below the earth's surface 16. Wellbore system 10 can include a rig (or derrick) 18 and a wellhead 40. A conveyance 30 (such as wireline, slickline, coiled tubing, downhole tractor, etc.), can be used to raise and lower a logging tool 50 into and out of the wellbore 12. Although not shown, the logging tool 50 could also be conveyed via a drill string and could, for example, be part of a BHA. The logging tool 50 can be used to evaluate the integrity of tubing strings in a wellbore 12 with multiple tubing strings 20, 22, 24, 26, 34, to Mth.

A casing string is a tubing string that is set inside a drilled wellbore 12 to protect and support production of fluids to the surface 16. In addition to providing stabilization and keeping the sides of the wellbore 12 from caving in on themselves, the casing string can protect fluid production from outside contaminants, such as separating any fresh water reservoirs from fluids being produced through the casing. Also known as setting pipe, casing a wellbore 12 includes running pipe (such as steel pipe) down an inside of the recently drilled portion of the wellbore 12. The small space between the casing and the untreated sides of the wellbore 12 (generally referred to as an annulus) can be filled with cement to permanently set the casing in place. Casing pipe can be run from a floor of the rig 18, connected one joint at a time, and stabbed into a casing string that was previously inserted into the wellbore 12. The casing is landed when the weight of the casing string is transferred to casing hangers which are positioned proximate the top of the new casing, and can use slips or threads to suspend the new casing in the wellbore 12. A cement slurry can then be pumped into the wellbore 12 and allowed to harden to permanently fix the casing in place. After the cement has hardened, the bottom of the wellbore 12 can be drilled out, and the completion process continued.

Sometimes the wellbore 12 is drilled in stages. Here, a wellbore 12 is drilled to a certain depth, cased and cemented, and then the wellbore 12 is drilled to a deeper depth, cased and cemented again, and so on. Each time the wellbore 12 is cased, a smaller diameter casing is used. The widest type of casing can be called conductor casing 20, and is usually about 30 to 42 inches in diameter for offshore wellbores and 12 to 16 inches in diameter for onshore wellbores 12. The next size in casing strings can be referred to as the surface casing 22, which can run several thousand feet in length. In some wellbores 12, intermediate casing 24 can be run to separate challenging areas or problem zones, such as areas of high pressure or lost circulation.

Generally, the last type of casing string run into the wellbore 12 is the production casing string 26, and is therefore the smallest diameter casing string. The production casing string 26 can be run directly into the producing reservoir 15. Additionally, a liner string 34 can be run into the wellbore 12 instead of a casing string. While a liner string 34 is very similar to other casing strings in that it can be made up of separate joints of tubing, the liner string 34 is not run the complete length of the wellbore 12. A liner string 34 can be hung in the wellbore 12 by a liner hanger (not shown). A production string 28 can then be run in the wellbore 12 to produce fluids from the producing zone 15 to the surface 16 and the rig 18. Each of the casing strings 20, 22, 24, 26, 34 can be secured in the wellbore 12 by cement that can fill at least a portion of an annulus (such as annuli 74, 76, 78, 80, 82, etc.) radially outside of the casing strings 20, 22, 24, 26, 34.

A logging facility 44 can collect measurements from the logging tool 50, and can include processing circuitry 45 for processing and storing the measurements gathered by the logging tool 50. The processing circuitry 45 can be used to determine the integrity of the tubing strings based on measurements received from the logging tool 50.

Over the life of the wellbore system 10, the integrity of many components of the system 10 is preferably monitored to detect and identify potential component failures as well as unsafe events that can occur due to component failures. One set of components in particular that are desirably to monitor are the tubing strings mentioned above, such as the casing strings 20, 22, 24, 26, 34, and the production string 28. It should be understood that more or fewer of these tubing strings can be utilized in the wellbore system 10 without limiting the current disclosure.

Monitoring the condition of each tubing string in oil and gas field operations can evaluate the integrity of the tubing string and indicate if a failure of the tubing string has occurred or is highly likely to occur. Such failures can be reduced thickness of a wall of the tubing string, a breach in the wall, corrosion, degradation, etc. Electromagnetic (EM) techniques are useful in inspection of these types of components, and one of the techniques operates based on producing and sensing eddy currents (EC) in these tubing strings. In the EC technique, a source (e.g. transmitting coil and/or permanent magnet) can create primary electromagnetic fields that extend from the source into the surrounding tubing strings. These primary electromagnetic fields can induce electrical eddy currents in the surrounding strings, which in turn can produce a secondary magnetic field which can contain magnetic signals from each of the tubing strings illuminated by the primary electromagnetic fields.

Characterization of the surrounding tubing strings can be performed by measuring and processing the secondary magnetic field. The illuminating (or primary) electromagnetic fields and the induced (or secondary) magnetic field can suffer high attenuation due to the inner-most tubing strings such that measureable signals may not be detectable by the logging tool 50 for the outer-most pipes. The high magnetic permeability of an inner-most tubing string can provide a path for a large portion of the magnetic flux of the primary fields to close inside the first pipe without reaching the outer pipes.

However, this disclosure provides a system and method to extend the magnetic flux lines of the primary fields radially outward to allow more of the outer-most tubing strings to be measured and therefore, their integrity monitored. The logging tool 50 can provide characterization of some of the inner tubing strings in the wellbore via EC measurement techniques. The logging tool 50 can also use a magnetizer to extend the EC measurement techniques by magnetizing the inner-most tubing string (or strings), which can minimize interference of the inner-most tubing strings with the primary and secondary fields and thereby allow these fields to extend to additional tubing strings. The logging tool can also provide multiple measurements of the tubing strings, by taking EC measurements of the tubing strings without using the magnetizer and then taking EC measurements using the magnetizer. These multiple measurements under varied conditions can provide increased accuracy in determining the integrity of the tubing strings. Increased accuracy can lead to significant improvements on the production and maintenance processes of multiple tubing string wellbore systems 10.

### Logging Tool Details and Operation:

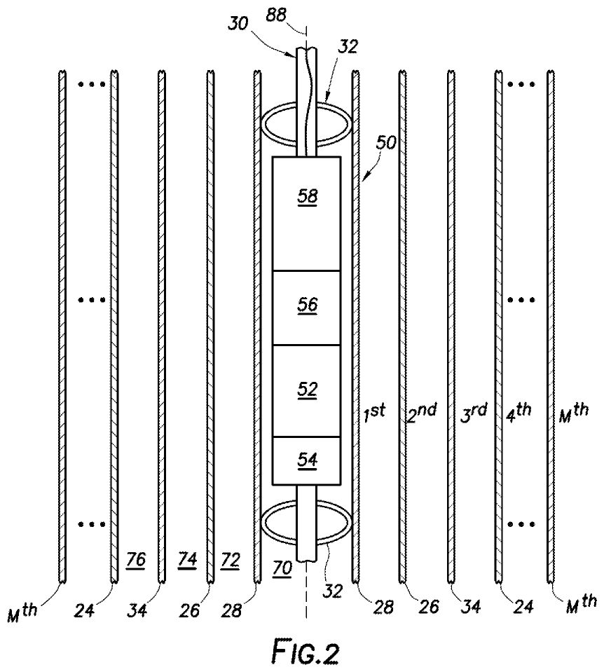

FIG. 2 shows a logging tool 50 positioned at a desired location in the wellbore 12 and surrounded by multiple tubing strings 28, 26, 34, 24, Mth (also shown as 1^{st}, 2^{nd}, 3^{rd}, and 4^{th} through Mth tubing strings). The logging tool 50 can include transmitters and receivers, as well as excitation and data acquisition electronics to implement frequency-domain or time-domain eddy current EC measurements in an EC module 54. The source(s) can produce primary electromagnetic fields that magnetically illuminate one-more of the surrounding tubing strings 28, 26, 34, 24, Mth. The receivers (or sensors) can detect the secondary magnetic field created by electrical eddy currents induced in the surrounding tubing strings 28, 26, 34, 24, Mth. If the source(s) are transmitter coils, then they can also be used as receivers. For example, when the primary electromagnetic fields are pulsed, the transmitters can be used to receive/detect the secondary magnetic field when they are not generating the primary electromagnetic fields. The primary electromagnetic fields can be generated by alternating current through a transmitting coil, moving a magnetic field generated by permanent magnets, etc.

The logging tool 50 can include a magnetizer 52 that can create a static magnetic field with one or more inner-most tubing strings 28, 26, thereby allowing the primary magnetic flux lines to extend radially outward to additional outer-most tubing strings Mth (such as 3^{rd}, 4^{th}, 5^{th}, 6^{th}, 7^{th}, 8^{th}, etc.). The logging tool 50 can also include sensors 56 for detecting downhole temperatures and pressures, as well as other measurement devices (e.g. induction array measurement devices), and a telemetry module 58 for transferring data/commands to/from the surface and other remote locations via both wired and wireless telemetry.

The logging tool 50 can be conveyed into the wellbore 12 via the conveyance 30, which is shown in FIGS. 1 and 2 as a wireline (or slickline) 30. However, other conveyances can be used in keeping with the principles of this disclosure. Centralizers 32 can be used to substantially center the logging tool 50 within the inner-most tubing string, but centralizers 32 may not be necessary if the magnetizer 52 is used to centralize the tool 50 in the tubing string. The logging tool 50 can take evaluation measurements at various locations along the wellbore 12 by creating primary electromagnetic fields and detecting the secondary magnetic field. One set of evaluation measurements can be taken at the location with the logging tool 50 configured as a conventional measurement device. A second set of evaluation measurements can be taken at the location with the logging tool 50 configured to magnetize one or more inner-most tubing strings, thereby increasing a radial distance the primary electromagnetic fields can travel, and increasing the amount of the secondary magnetic field returned to the tool 50. These sets of evaluation measurements from the different tool 50 configurations can be used to improve accuracy of tubing string integrity measurements.

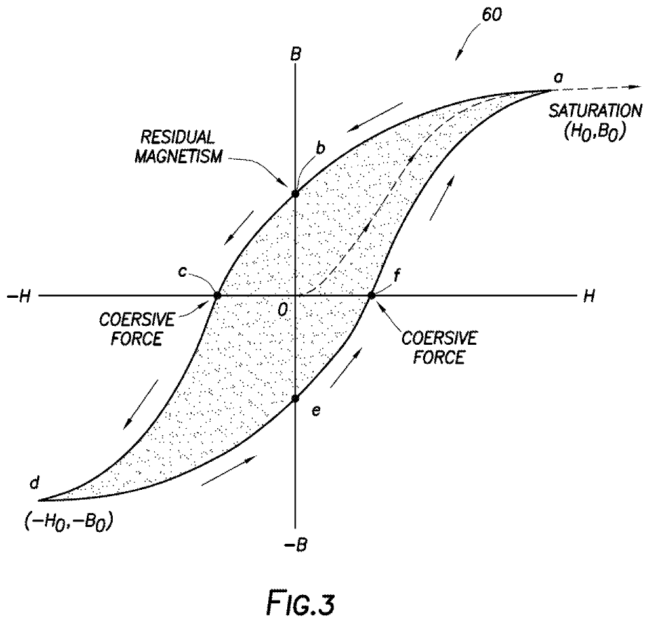

FIG. 3 gives a magnetic hysteresis loop 60 that graphically shows the behavior of a ferromagnetic material such as a tubing string 28, 26. The parameters B and H denote the magnetic flux density and the magnetic field strength, respectively. FIG. 3 shows that the relationship between B and H is non-linear. Starting with an un-magnetized tubing string 28, 26, both B and H will be at zero, which corresponds to point 0 on the magnetization curve. If the magnetic field strength H increases, the flux density B will also increase as shown by the curve from point 0 to point a as it heads towards saturation. Now, if the magnetic field reduces to zero, the magnetic flux will not reach zero due to the residual magnetism present within the tubing string and this is shown on the curve from point a to point b. To reduce the flux density at point b to zero we need to reverse the magnetic field in the tubing string.

The magnetizing force which must be applied to null the residual flux density is called a “coercive force.” This coercive force reverses the magnetic field thereby re-arranging the molecular magnets until the tubing string becomes un-magnetized at point c. An increase in this reverse magnetic field causes the tubing string to be magnetized in the opposite direction and increasing this magnetization field further will cause the tubing string to reach its saturation point but in the opposite direction (i.e. point d on the curve). If the magnetizing field is reduced again to zero the residual magnetism present in the core will be in reverse at point e. Again, reversing the magnetizing field through the tubing string 28, 26 into a positive direction will cause the magnetic flux to reach zero (i.e. point f on the curve) and as before increasing the magnetization field further in a positive direction will cause the tubing string to reach saturation at point a. Therefore, the B-H curve follows the path of a-b-c-d-e-f-a as the magnetizing field in the tubing string alternates between a positive and a negative value such as the cycle of an AC voltage. This path is called a magnetic hysteresis loop 60.

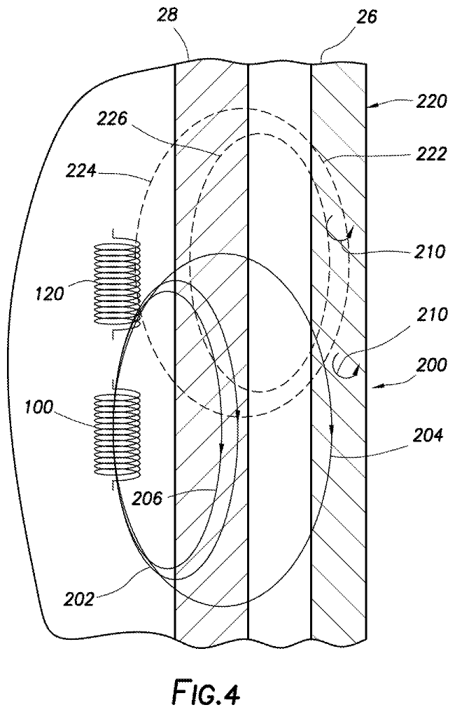

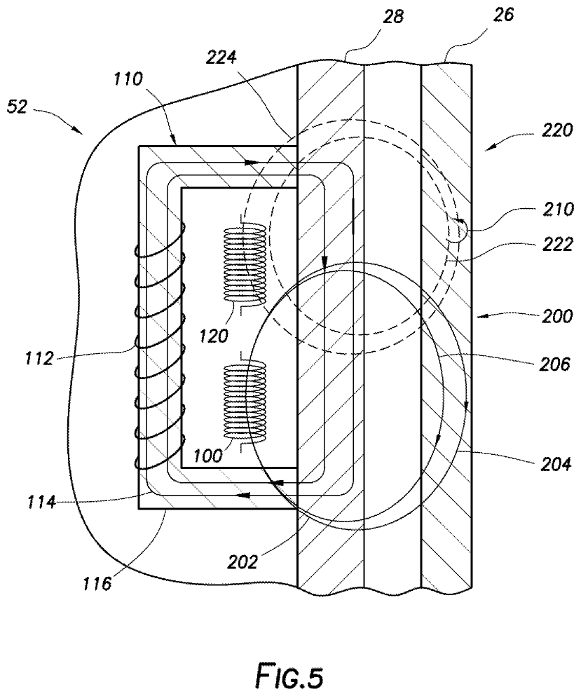

For ferromagnetic materials such as steel tubing strings, the ratio of the flux density to field strength (B/H) is not constant but varies with the flux density. However, for non-magnetic materials such as woods or plastics, this ratio can be considered as a constant and this constant is known as μ0, the permeability of free space, (μ0=4π×10−7 H/m). Below the saturation level, the magnetic permeability of the tubing string is large (e.g. tubing strings 28, 26 in FIGS. 4 and 5). Thus, a large percentage of the flux is attracted inside the tubing string due to low magnetic reluctance (or magnetic resistance) of the tubing string. But, above the saturation level, the flux leaks outside the tubing string due to the large magnetic reluctance (or magnetic resistance) of the tubing string. Therefore, when inspecting outer-most strings 34, 24, and Mth in a multiple concentric tubing string inspection scenario (e.g. FIG. 2), it may be desirable to magnetize the first and possibly the second ones of the inner-most tubing strings 28, 26, 34 beyond the saturation level so that a larger percentage of the interrogating flux passes across the inner-most tubing strings 28, 26, 34, reaching the outer-most tubing strings 34, 24, Mth, creating eddy currents, and radiating the secondary magnetic fields back to the tool 50. Below the saturation points, the large permeability of the tubing string 28, 26, 34 imposes large attenuation on the interrogating fields while beyond the saturation points, the magnetic permeability drops drastically leading to much lower attenuation of the fields passing across the inner-most tubing strings with more of the primary electromagnetic field flux lines reaching the outer-most tubing strings.

FIG. 4 illustrates the conventional configuration where the magnetizer 52 is not used. One or more sources 100 (i.e. transmitter coils, permanent magnetics, etc.) can be used to create one or more primary electromagnetic fields 200, with flux lines 202 that illuminate the tubing strings 28, 26. If the string 28 is made from a magnetic material (such as steel), then a greater portion 206 of the flux lines 202 may be attracted inside the string 28 and only a portion 204 of the flux lines 202 may extend to the second string 26. The flux lines 206 and 204 can induce eddy currents 210 in the respective strings 28, 26, thereby creating a secondary magnetic field 220 with secondary flux lines 222 that are radiated back to the receivers 120. The receivers 120 can measure the secondary flux lines 222 that extend back to the tool 50. These measurements can be analyzed to determine integrity of the strings 28, 26. With fewer flux lines entering the second string 26, then fewer eddy currents 210 may be generated, thereby generating a less intense secondary magnetic field, which may result in reduced sensitivity of the tool 50 to the conditions of the outer string 26. A portion 226 of the secondary flux lines 222 may be attracted inside the string 28, reducing the number of flux lines 222 that reach the receivers 102. As can be seen, the radial penetration of the tool 50 can be impacted by the amount of flux lines that are attracted inside the inner-most tubing strings 28, 26, thereby reducing the amount of flux lines that extend past the inner string 28.

FIG. 5 illustrates a configuration that uses a magnetizer 52 to magnetize one or more of the strings 28, 26. The magnetizer 52 can include a structure 116 that can be various shapes, such as a “C” shape illustrated in FIG. 5. The structure 116 can provide support for a static magnetic source 112, which can be a permanent magnetic (or magnetics), a transmitter coil(s) with DC current, etc. to produce a static magnetic field 110 and static magnetic flux lines 114. The structure 116 can be coupled to the tubing string 28 such that the flux lines 114 have a return path in the tubing string 28 to close the loop of the flux lines 114. The source 112 can produce enough flux lines 114 to magnetically saturate the tubing string 28 with the static magnetic field 110. Once the string 28 is magnetically saturated, the string 28 becomes virtually transparent to the primary electromagnetic fields 200 and the secondary field 220. Therefore, a greater portion (if not all) of the flux lines 202 of the primary fields and flux lines 222 of the secondary field can pass through the string 28, and extend to the tubing string 26 or back to the tool 50, respectively. With a larger amount of the primary flux lines 202 reaching the outer string 26, more eddy currents can be produced in the string 26, thereby producing a stronger secondary magnetic field 220, which, in turn, can result in stronger measurements of the secondary magnetic flux field 220 by the receivers 120 (or transmitters 100, if so configured). This increased intensity of the secondary magnetic field 220 can provide increased accuracy of integrity measurements for the outer strings 26 through Mth (see FIG. 2).

Additionally, to further increase the radial distance of the tool 50, the source 112 can increase the strength of the static magnetic field 110 such that the 2nd string 26 also becomes saturated, thereby increasing radial penetration of the primary flux lines 202 past the strings 28, 26 to the outer tubing strings 34, 24, Mth (refer to FIG. 2). Magnetically saturating the 2^{nd} string can be possible with a space between the 1^{st} and 2^{nd} strings being minimized, so that the air gap in between is very small and the reluctance of the air gap is not much larger than all reluctances in the magnetic circuit. The 2nd string 26 can be saturated by the static magnetic field 110 once the inner-most string 28 is saturated and flux lines escape the string 28 and enter the string 26. With a sufficient number of escaped flux lines entering string 28, it too can become saturated. It is foreseeable that the 1^{st} and possibly the 2^{nd} inner tubing strings can be saturated by the static magnetic source 112, thereby significantly improving the radial penetration of the logging tool 50.

The source 112 can also be used as a transmitter or a receiver, when the source is not being used for producing the static field. The source 112 can also include multiple coils and/or permanent magnets for producing the static magnetic field 110. The coils or permanent magnets of the source 112 can be distributed at various locations on and/or in the axial and non-axial arms of the structure 116.

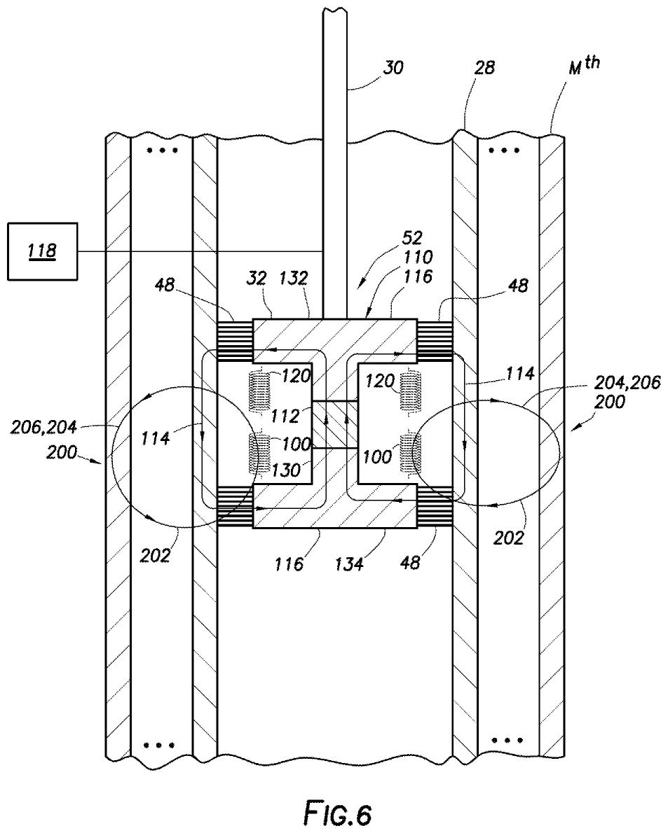

FIGS. 6-8 illustrate various embodiments of the magnetizer 52. The other components 54, 56, and 58 of the logging tool 50 are not shown in FIGS. 6-8 for clarity. The magnetizer 52 of FIG. 6 is shown positioned within an inner-most tubing string 28 which is also positioned within multiple tubing strings Mth. The structure 116 can also act as a centralizer 32 without additional centralizers being used. The structure 116 is shown to have an “I” shape, with the top and bottom portions 132, 134 extending radially in both directions and a center portion 130 connecting the top and bottom portions 132, 134 together. The extended top and bottom portions 132, 134 can include brushes 48 at their radial ends which can provide a magnetic coupling of the magnetizer 52 to the tubing string 28. A cross-section of these portions 130, 132, 134 can be various shapes, such as circular, triangular, rectangular, oval, polygon, etc. The brushes 48 can be extendable/retractable to facilitate tripping the tool 50 in and out of the wellbore 12, but it is not a requirement that the brushes 48 are extendable/retractable. They can also be resilient such that they are compliant to varying dimensions within tubing string 28 as the logging tool 50 moves through the wellbore 12 while the brushes 48 maintain the magnetic coupling to the tubing string 28.

The source 112 (which can be one or more coils and/or one or more permanent magnetics) can create the static magnetic field 110 with flux lines 114. In this example, the flux lines 114 extend into the tubing string 28 at multiple locations, saturating the tubing string 28 at those locations and allowing the primary electromagnetic fields 200 of the transmitters 100 to extend radially to the Mth tubing string, with minimal loss of flux lines 202 as they pass through the tubing string 28. The portions 204 and 206 of the flux lines 202 are shown to both be extended to the Mth tubing string. However, it is not a requirement that all flux lines of portions 204 and 206 extend to the Mth tubing string. Some of the flux lines 202 can be attracted into intermediate tubing strings between string 28 and the Mth string. Yet, using the magnetizer 52 to saturate the inner-most tubing string 28, an increased amount of the primary electromagnetic fields 200 will be extended to the Mth tubing string by the source transmitter 100 than can be extended by a same powered source 100 without using the magnetizer 52 in the same tubing string configuration. As stated previously, the flux lines 202 can induce eddy currents 210 in the Mth tubing string, which can create a secondary magnetic field 220 that can be detected by the receivers 120. The detected magnetic field 220 can be evaluated to determine integrity of the Mth tubing string.

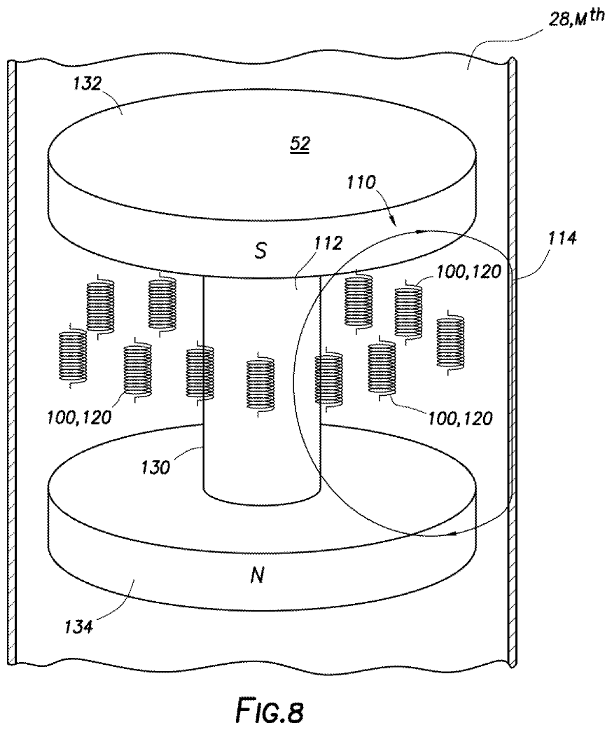

It should be clearly understood that the structure 116 can have many other configurations (or shapes) other than the one shown in FIG. 6. FIG. 6 shows the structure 116 as an “I” shaped structure that resembles a cross-section of an I-beam. However, the structure 116 can also resemble an “I” shape that is revolved about a center axis, forming disks for top and bottom portions 132, 134 of the structure 116, and a cylinder for a center portion 130 of the structure 116 (similar to configuration in FIG. 8). In this configuration the brushes 48 can extend circumferentially around each top and bottom portion 132, 134, providing magnetic coupling around the circumference of the portions 132, 134 to the tubing string 28. The brushes 48 can be continuous or at spaced apart locations around the circumference of the portions 132, 134. As used herein “brushes” refer to any material and/or assembly that provides a resilient coupling between the magnetizer 52 and the inner-most tubing string, where the brushes 48 magnetically couple the magnetizer 52 to the inner-most tubing string (e.g. tubing string 28).

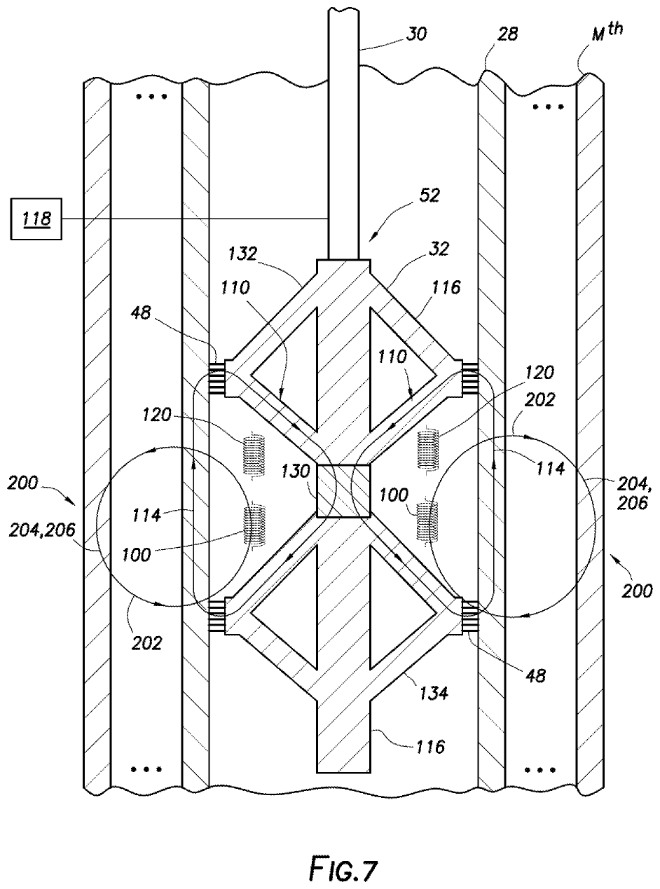

FIG. 7 shows yet another configuration (or shape) of the structure 116 with a dual-triangle shaped feature forming the top portion 132, another dual-triangle shaped feature forming the bottom portion 134, with a center section 130 joining the two dual-triangle features together. Each dual-triangle feature has two triangle shaped pieces that are joined at the base of each triangle with each triangle extending in opposite directions. The peak of each triangle piece can include magnetic brushes 48 that resiliently couple the magnetizer 52 to the inner-most tubing string (e.g. string 28). The source 112 (which can be one or more coils and/or one or more permanent magnetics) can create the static magnetic field 110 with flux lines 114. Again, the flux lines 114 extend into the tubing string 28 at multiple locations, saturating the tubing string 28 at those locations and allowing the primary electromagnetic fields 200 to extend radially to the Mth tubing string, with minimal loss of flux lines 202 as they pass through the tubing string 28. Again, the flux lines 202 can induce eddy currents 210 in the Mth tubing string, which can create the secondary magnetic field 220 that can be detected by the receivers 120. The detected magnetic field 220 can be evaluated to determine integrity of the Mth tubing string.

The 2D shape shown in FIG. 7 can also be revolved around a center axis to form a 3D shape that may appear as two “revolved” shapes attached together in the center by the center portion 130, where the source 112 is shown. However, it should be clear that multiple sources 112 can be distributed in and/or on the structure 116 along the paths of the flux lines 114. The “revolved” shape can be represented by two dinner plates bonded together with each bottom facing away from each other, and with a center structure extending between each dinner plate. In this configuration the brushes 48 can extend circumferentially around each top and bottom portion 132, 134, providing magnetic coupling around the circumference of the portions 132, 134 to the tubing string 28. The brushes 48 can be continuous or at spaced apart locations around the circumference of the portions 132, 134. The structure 116 can also be made from two spheres (not shown) forming the top and bottom portions 132, 134 attached together by a center portion 130 with brushes 48 attached to an exterior portion of a surface of each sphere that is proximate the inner-most tubing string. The flux lines 114 would be similarly formed in the top and bottom portions 132, 134 and the inner-most tubing string.

FIG. 8 shows the configuration of the magnetizer 52 that is an “I” shape revolved around a center axis forming disk shapes for the top and bottom portions 132, 134, and forming a cylinder for the center portion 130. The source(s) 112 can create the static magnetic field 110 with the flux lines 114 that travel through the magnetizer 52 and a location of the tubing string 28 at azimuthal locations around the magnetizer 52. Various transmitters/receivers 100, 120 can be positioned circumferentially around the center portion 130. These transmitters/receivers 100, 120 can be used to transmit the primary electromagnetic fields 200 and detect the secondary field 220. It should also be understood that these transmitters/receivers 100, 120 can also be made up of dedicated transmitters 100, and dedicated receivers 120, without using a same coil for both, which can be the case when magnetic fields are pulsed. By positioning the transmitters/receivers 100, 120 around the center portion 130, the azimuthal orientation of a degraded integrity condition of an outer tubing string (26, 34, 24, 22, etc.) can be determined by knowing which receiver 120 detected the degraded integrity condition. It should be clearly understood that the transmitters/receivers 100, 120 are not required to be positioned between the top and bottom portions 132, 134 of the magnetizer. For example, they can be positioned circumferentially around a center axis of the magnetizer 52, but positioned axially above the top portion 132 or axially below the bottom portion 134. However, it is preferable to position them between the top and bottom portions 132, 134 since the intensity of the returned secondary magnetic field 220 from the outer tubing strings can be higher there.

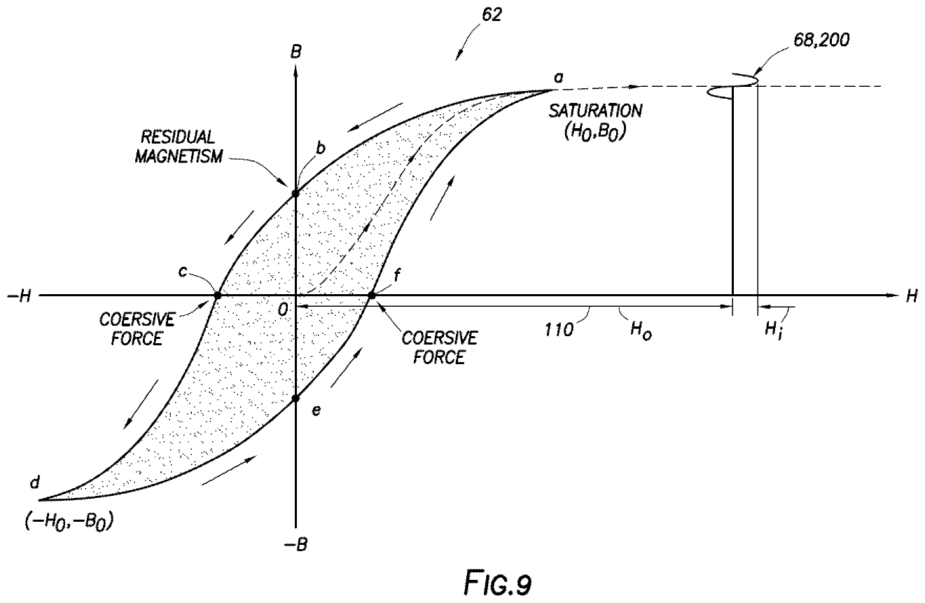

FIG. 9 gives a magnetic hysteresis loop 62 that graphically shows the behavior of a ferromagnetic material such as a tubing string 28, 26, along with an interrogating primary electromagnetic field 200 with amplitude Hi. The magnetic hysteresis loop 62 is similar to the magnetic hysteresis loop 60 in FIG. 3. FIG. 9 illustrates the strength HO of the magnetizing static field 110 and interrogating primary electromagnetic field 200 when pushing the tubing strings 28, 26 deep into a saturation region. In this example, it is preferred that the interrogating magnetic field 200 should be small enough not to cause drastic changes in the effective permeability of the magnetized tubing strings 28, 26 (i.e. B/H≈constant). The strength of the magnetizing static field 110 should be large enough to magnetize one or possibly two of the tubing strings beyond the saturation level. However, the strength of the interrogating primary electromagnetic fields 200, which can be a transient field, should be small enough not to take the tubing strings out of the saturation level.

### Methods of Operation:

FIG. 10 shows a flow diagram of a method 140 which can be referred to as a conventional inversion scheme that can include operations to convert data, acquired from the magnetic receivers 120, to a representation of a number of tubing strings in the multiple tubing string wellbore as well as the properties and dimensions of the tubing strings. In operation 142, EC measurement data can be acquired from the logging tool 50 which is configured without the magnetizer 52 enabled (e.g. see FIG. 4). The data acquired by the receivers 120 can include data from the secondary magnetic field 220 received from one or more of the tubing strings 28, 26, 34, 24, 22 (see FIGS. 1 and 2). The magnetizer can also be used in the method 140, which would merely allow the logging tool to receive EC measurement data from additional outer-most tubing strings.

In operation 144, data stored in a library can be provided for comparison to the acquired data from operation 142. The library data could have been created from previous data logging operations and/or previous forward modeling operations. In operation 146, forward modeling of the multiple tubing strings in the wellbore 12 is performed and results provided to operation 148. The forward modeling results can be compared to the numerical inversion of the acquired data from operation 142 to determine integrity parameters of each of the tubing strings 28, 26, 34, 24, 22, Mth. The forward modeling can perform multiple modeling iterations to produce modeled data that substantially matches the inversion of the acquired data. By tweaking the modeling parameters, such as tubing string wall thickness, air gaps (or annuli), cement, tubing material, etc., so the modeled data substantially matches the inverted acquired data, then the modeled data parameters can be used to estimate the actual parameters of the tubing strings 28, 26, 34, 24, 22, Mth. Similar results can be obtained when the inversion of the acquired data substantially matches the library data. When that inverted data is matched, then operation 149 can determine such things as existence of defects, type of defects, dimensions of defects, problems in perforations, etc. and can output these results to an operator and/or the processing circuitry 45 for initiating corrective actions or planning maintenance activities.

Effects due to the presence of a sensor housing, transmitter magnetic core, a pad structure, mutual coupling between sensors, mud and cement can be corrected by using a priori information on these parameters, or by solving for some or all of them during the inversion process in operation 148. Since all of these effects are mainly additive, they can be removed using calibration schemes. A multiplicative (or scaling) portion of the effects can be removed in the process of calibration to an existing log. All additive, multiplicative and any other non-linear effect can be solved for by including them in the inversion process as a parameter.

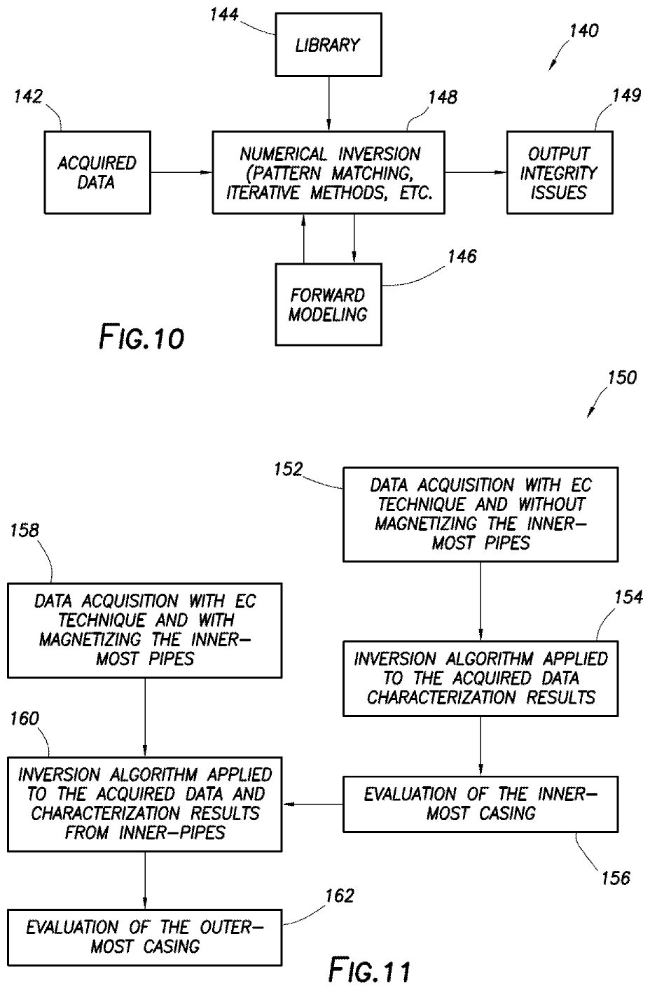

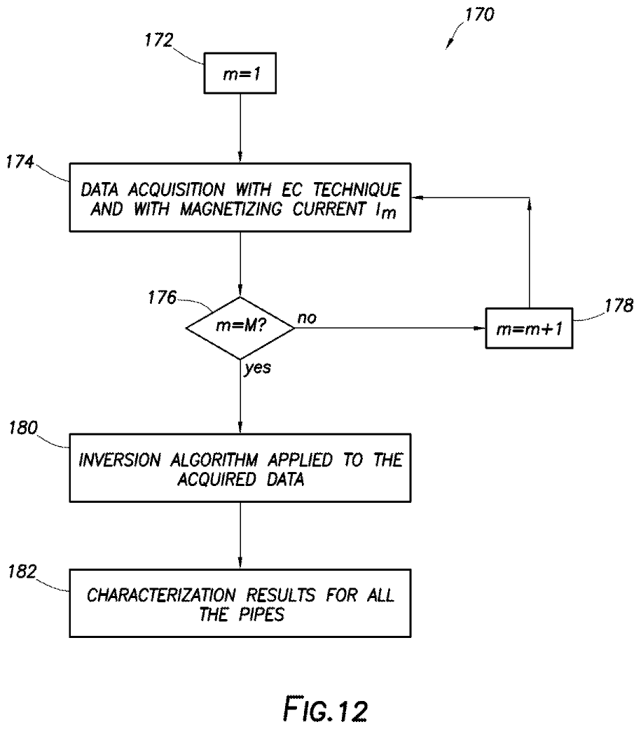

FIG. 11 shows a flow diagram of a method 150 which can be referred to as a complete inversion scheme that can include operations to acquire data from the multiple tubing strings 28, 26, 34, 24, 22, Mth by acquiring data with and without the magnetizer enabled. The complete inversion scheme can include operations to convert data, acquired from the magnetic receivers 120, to a representation of a number of tubing strings in the multiple tubing string wellbore as well as the properties and dimensions of the tubing strings. In operation 152, EC measurement data is acquired from the logging tool 50 which is configured, without the magnetizer 52 enabled (e.g. FIG. 4). The data acquired by the receivers 120 can include data from the secondary magnetic field 220 received from one or more of the inner tubing strings 28, 26, 34, 24, 22. Again, in this configuration, the inner-most tubing string 28 is not magnetically saturated by a static magnetic field 110. Therefore, a portion 206 of the flux lines 202 is attracted into the inner-most tubing string 28 with the remaining flux lines 202 radiating one or more of the other tubing strings 26, 34, 24, 22. Please note that the inner tubing strings 28, 26, 34, 24 can overlap designations of outer tubing strings 26, 34, 24, 22, Mth, with the inner-most generally referring to the production string 28 (when the string 28 is installed) and the outer-most string generally referring to the Mth string in the multiple tubing string configuration shown in FIGS. 1 and 2. Of course other tubing string configurations than those in FIGS. 1 and 2 are possible in keeping the principles of the current disclosure.

In operation 154, the acquired data is inverted and compared to modeled data produced via forward modeling. Modeling iterations are performed to produce various model data. When the model data substantially matches the inversion of the acquired data, the parameters of the inner-most tubing strings 28, 26 can be determined in operation 156 from the parameters of the forward model that produced the matching model data.

In operation 158, EC measurement data is again acquired from the logging tool 50 which is reconfigured to enable the magnetizer 52 (e.g. FIG. 5). The data acquired by the receivers 120 can include data from the secondary magnetic field 220 received from one or more of the outer tubing strings 26, 34, 24, 22, Mth. In this configuration, the inner-most tubing string 28 is magnetically saturated by a static magnetic field 110. Therefore, little to none of the flux lines 202 are attracted into the inner-most tubing string 28 with a majority, if not all, of the flux lines 202 radiating one or more of the outer tubing strings 26, 34, 24, 22, Mth.

In operation 160, the acquired data from the outer tubing strings 26, 34, 24, 22, Mth is received from operation 158, and the parameter results for the inner-most tubing strings 28, 26 are received from operation 156. The inversion process is applied to the outer tubing string acquired data and combined with the inner-most tubing string parameter results to produce parameter results for the outer tubing strings 26, 34, 24, 22, Mth. The dimensions and properties of the inner-most pipes are known, and the outer-most pipes can be characterized based on the measurements of EC while the inner-most pipes 28 and/or 26 are magnetized beyond the saturation level. The properties of the tubing strings 26, 34, 24, 22, Mth can be estimated before and/or during the characterization of the defects in the tubing strings using the inversion algorithms. Similar approach is taken when magnetizing the pipes for outer pipe characterizations. The properties of the tubing strings 26, 34, 24, 22, Mth are estimated with the inner tubing strings 28, 26 being magnetized. Thus, new magnetic properties are determined for the inner tubing strings 28, 26 that are different from those found before magnetizing the tubing strings 28, 26. Estimated magnetic permeabilities for the inner tubing strings will be much smaller when magnetizing these tubing strings 28, 26.

FIG. 12 shows a flow diagram of a method 170 where the magnetization of the inner tubing strings 28, 26 can be implemented by a coil excited with different current levels Im, where m=1, . . . , M. By this approach, M measurements are implemented, with measurements taken at each excitation current Im. Higher magnetizing currents lead to higher magnetic fields and thus pushing the tubing string 28 (and possibly 26) more toward saturation (lowering their effective permeabilities). In operation 172, m is set to 1 and the initial value of m is provided to operation 174, where EC measurements are taken with the static magnet field source magnetizing current Im=I1. The EC measurements acquire data from the secondary magnetic field 220 from the tubing strings in the wellbore system 10. In operation 176, the value of m is tested to see if it equals the max value M. If not, m is incremented in operation 178 and new EC measurements are taken in operation 174 with the magnetizing current Im=I2.

This process continues until EC measurements are taken in operation 174 for all magnetizing currents up to Im=IM. With m=M, operation 176 indicates YES, so all of the EC measurement data is provided to operation 180, where the inversion algorithm is applied to the EC measurement data, and results for all the tubing strings in the wellbore configuration are determined in operation 182. Method 170 collects all of the EC measurements for the range of magnetization currents Im, and characterizes the tubing strings 28, 26, 34, 24, 22, Mth simultaneously based on the acquired EC measurement data. In this method 170, the magnetic properties of the tubing strings depend on the magnetizing current and are estimated for each current level Im. On the other hand, the geometrical dimensions of the tubing strings are common for all the current levels and these are common optimizable parameters when employing the whole set of data for characterization of all the tubing strings.

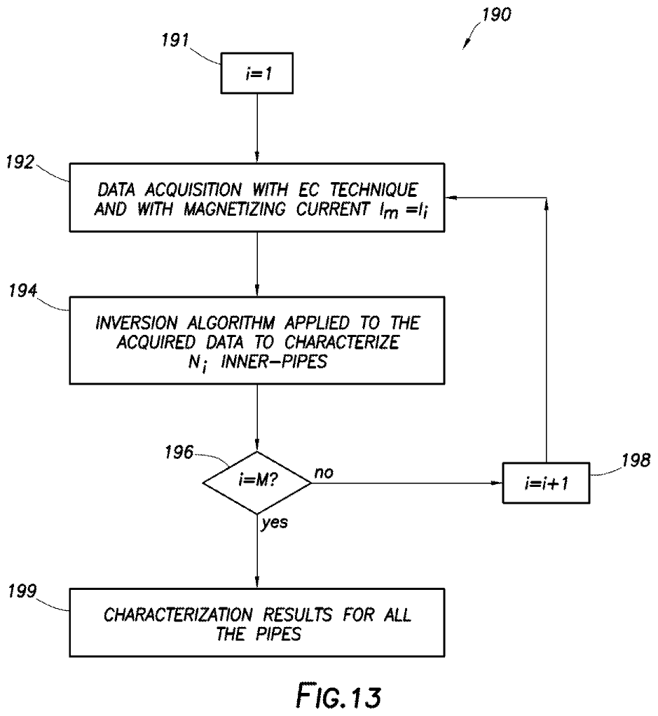

Similar to FIG. 12, FIG. 13 shows a flow diagram of a method 190 where the magnetization of the inner tubing string 28 (and possibly 26) can be implemented by a coil excited with variable currents Im, where m=1, . . . , M. By this approach, M measurements are implemented, with measurements taken at each excitation current Im. Higher magnetizing currents lead to higher magnetic fields and thus pushing the tubing string 28 more toward saturation (lowering their effective permeabilities). In operation 191, m is set to 1 and the initial value of m is provided to operation 192, where EC measurements are taken with the static magnet field source magnetizing current Im=I1. The EC measurements acquire data from the secondary magnetic field 220 from the tubing strings in the wellbore system 10. In operation 194, the EC measurement data taken in operation 192 is processed by the inversion algorithm to characterize the inner tubing strings Nm, which is N1 for the first logic loop.

In operation 196, the value of m is tested to see if it equals the max value M. If not, m is incremented in operation 198 and new EC measurements are taken in operation 192 with the magnetizing current Im=I2. In operation 194, the newly acquired EC measurement data, taken in operation 192, is processed by the inversion algorithm to characterize the inner tubing strings N2. This process continues until EC measurements are taken in operation 192, and inverted in operation 194 with the magnetizing current Im=IM. With m=M, operation 196 indicates YES, so all of the results of the EC data inversions performed in operation 194 can be provided to operation 199. Method 190 collects all of the EC measurements for the range of magnetization currents Im, and characterizes the tubing strings 28, 26, 34, 24, 22, Mth sequentially from inner tubing strings to the outer tubing strings based on the acquired EC measurement data, such that at each operation 194 one or more new outer pipes are characterized while the characterization results for the inner pipes from the previous operations 194 are known, or can be used as initial values for characterization of the inner pipes in the current operation 194.

Therefore, a logging tool 50 for evaluating integrity of a tubing string 28, 26, 34, 24, Mth in a wellbore 12 with multiple tubing strings 28, 26, 34, 24, Mth is provided. The tool 50 can include at least one primary source 100 that generates electromagnetic excitation within the tubing strings 28, 26, 34, 24, Mth with at least one primary electro-magnetic field 200, at least one magnetic field sensor 120 that detects a secondary magnetic field 222 produced by at least one of the tubing strings 28, 26, 34, 24, Mth, a magnetizer 52 that can magnetize a portion of an inner-most tubing string 28 in the wellbore 12 such that the portion of the inner-most tubing string 28 has an increased magnetic transparency to the primary and secondary fields 200, 220 when the magnetizer 52 is enabled. The magnetizer 52 can include at least one static magnetic source 112, and a structure 116 that magnetically couples the static magnetic source 112 to the inner-most tubing string 28. The magnetizer 52 can also magnetize a portion of the inner tubing string 26 in the wellbore 12 such that the portion of the inner tubing string 26 has an increased magnetic transparency to the primary and secondary fields 200, 220 when the magnetizer 52 is enabled.

For any of the foregoing embodiments, the tool may include any one of the following elements, alone or in combination with each other:

The tool can also include a controller 118 that receives sensor data from the magnetic field sensor 120 and determines the integrity of at least one of the tubing strings 28, 26, 34, 24, Mth based on the sensor data. The integrity can include an indication of tubing string degradation, with the tubing string degradation being at least one of erosion, corrosion, metal migration, oxidation, chemical degradation, damage due to physical impacts, and/or damage due to stress and/or strain on the tubing string.

A first magnetic coil 100 can selectively be the primary magnetic source 100 and the secondary magnetic field sensor 120. The primary source 100 can include multiple primary sources 100 and the magnetic field sensor 120 can include multiple magnetic field sensors 120. The primary sources 100 and magnetic field sensors 120 can be circumferentially positioned at various azimuthal locations around the magnetizer 52. The magnetic field sensors 120 can detect the secondary magnetic field 220 at the various azimuthal locations, and the controller 118 can determine an azimuthal direction of a degradation in integrity of a respective one of the tubing strings 28, 26, 34, 24, Mth based on sensor data received from the magnetic field sensors 120.

The structure 116 can include magnetic brushes 48 that can magnetically couple the structure 116 to the inner-most tubing string 28 (and possibly string 26). The structure 116 can include top and bottom portions 132, 134, and a center portion 130, where the static magnetic source 112 can be positioned proximate the center portion 130 and can create a static magnetic field 110 with static magnetic flux lines 114 that form through the top and bottom portions 132, 134 and through a portion of the inner-most tubing string 28 (and possibly string 26), thereby magnetizing the portion of the inner-most tubing string 28 (and possibly string 26). The top and bottom portions 132, 134 can each be shaped as one of a disk, a revolved shape, an ovoid, and a sphere that extend radially from the center portion 130. The magnetic brushes 48 can be circumferentially positioned on an outer-most radial surface of each of the top and bottom portions 132, 134.

The magnetizer 52 can magnetically saturate the portion of the inner-most tubing string 28 (and possibly string 26) such that the portion of the inner-most tubing string 28 (and possibly string 26) is substantially transparent to the primary and secondary magnetic fields 200, 220 when the magnetizer 52 is enabled.

Additionally, a method for evaluating integrity of one or more tubing strings 28, 26, 34, 24, Mth in a wellbore 12 is provided which can include the operations of positioning a logging tool 50 with a magnetizer 52 at a location in the wellbore 12, magnetizing via the magnetizer 52 a portion of an inner-most one of the tubing strings 28 with a static magnetic field 110, exciting the tubing strings 28, 26, 34, 24, Mth with at least one primary electro-magnetic field 200 created by a primary source 100 of the logging tool 50.

The operations can also include inducing electrical eddy currents 210 in the one or more tubing strings 28, 26, 34, 24, Mth, detecting via the logging tool 50 a secondary magnetic field 222 created by the electrical eddy currents 210 in the one or more tubing strings 28, 26, 34, 24, Mth with the magnetizer 52 enabled, and determining the integrity of the one or more tubing strings 28, 26, 34, 24, Mth based on the detecting.

For any of the foregoing embodiments, the method may include any one of the following operations, alone or in combination with each other:

The operations can also include increasing the magnetization of the portion of the inner-most tubing string 28 such that the portion is magnetically saturated, causing the portion to be substantially transparent to the primary and secondary fields 200, 220. Producing sensed data by sensing the secondary magnetic field 220 via at least one magnetic field sensor 120, and determining integrity can include applying an inversion algorithm to the sensed data to characterize the integrity of the one or more tubing strings 28, 26, 34, 24, Mth.

The operations can also include exciting the tubing strings 28, 26, 34, 24, Mth with the at least one primary electromagnetic field 200 with the magnetizer 52 disabled and prior to the magnetizing, inducing electrical eddy currents 210 in the one or more tubing strings 28, 26, 34, 24, Mth, detecting via the logging tool 50 the secondary magnetic field 220 created by the electrical eddy currents 210 in the one or more tubing strings 28, 26, 34, 24, Mth with the magnetizer 52 disabled, and determining the integrity of the one or more tubing strings 28, 26, 34, 24, Mth based on the detecting the second magnetic field 220 with the magnetizer disabled.

The operations can also include that the detecting the secondary magnetic field 220 with the magnetizer 52 disabled can include producing a first sensed data by sensing the secondary magnetic field 220 via the magnetic field sensor 120 with the magnetizer 52 disabled, and the determining the integrity of the one or more tubing strings 28, 26, 34, 24, Mth with the magnetizer 52 disabled can include applying an inversion algorithm to the first sensed data to characterize the integrity of the one or more tubing strings 28, 26, 34, 24, Mth prior to magnetizing the inner-most tubing string 28.

The operations can also include that the detecting the secondary magnetic field 220 with the magnetizer 52 enabled can include producing a second sensed data by sensing the secondary magnetic field 220 via the magnetic field sensor 120 with the magnetizer 52 enabled, and the determining the integrity of the one or more tubing strings 28, 26, 34, 24, Mth with the magnetizer 52 enabled can include applying an inversion algorithm to the second sensed data to characterize the integrity of the one or more tubing strings 28, 26, 34, 24, Mth with the magnetizer 52 enabled and combining the integrity characterization of the one or more tubing strings 28, 26, 34, 24, Mth with the magnetizer 52 disabled.

The operations can also include repeating the exciting, inducing, detecting, and determining operations while incrementally increasing the static magnetic field 110 between each iteration of these operations, and characterizing the tubing strings 28, 26, 34, 24, Mth by applying an inversion algorithm to data acquired during the detecting after each iteration of these operations or after a last iteration of these operations.

Although various embodiments have been shown and described, the disclosure is not limited to such embodiments and will be understood to include all modifications and variations as would be apparent to one skilled in the art. Therefore, it should be understood that the disclosure is not intended to be limited to the particular forms disclosed; rather, the intention is to cover all modifications, equivalents, and alternatives falling within the spirit and scope of the disclosure as defined by the appended claims.

1. A logging tool for evaluating integrity of a tubing string in a wellbore with multiple tubing strings, the tool comprising:
at least one primary source that generates electromagnetic excitation within the tubing strings with at least one primary electro-magnetic field;
at least one magnetic field sensor that detects a secondary magnetic field produced by at least one of the tubing strings; and
a magnetizer that magnetizes a portion of an inner-most tubing string in the wellbore such that the portion of the inner-most tubing string has an increased magnetic transparency to the primary and secondary fields when the magnetizer is enabled, the magnetizer comprising;
at least one static magnetic source, and
a structure that magnetically couples the static magnetic source to the inner-most tubing string.

2. The tool of claim 1, further comprising a controller that receives sensor data from the magnetic field sensor and determines the integrity of at least one of the tubing strings based on the sensor data.

3. The tool of claim 2, wherein the integrity includes an indication of tubing string degradation, and wherein the tubing string degradation is at least one of a group consisting of erosion, corrosion, metal migration, oxidation, chemical degradation, damage due to physical impacts, and damage due to stress and/or strain on the tubing string.

4. The tool of claim 1, wherein a first magnetic coil includes the primary magnetic source and the secondary magnetic field sensor.

5. The tool of claim 1, wherein the primary source comprises multiple primary sources.

6. The tool of claim 5, wherein the magnetic field sensor comprises multiple magnetic field sensors.

7. The tool of claim 6, wherein the primary sources and magnetic field sensors are circumferentially positioned at various azimuthal locations around the magnetizer.

8. The tool of claim 7, wherein the magnetic field sensors detect the secondary magnetic field at the various azimuthal locations, and the controller determines an azimuthal direction of a degradation in integrity of a respective one of the tubing strings based on sensor data received from the magnetic field sensors.

9. The tool of claim 1, wherein the structure comprises magnetic brushes that magnetically couple the structure to the inner-most tubing string.

10. The tool of claim 1, wherein the structure comprises top and bottom portions, and a center portion, and wherein the static magnetic source is positioned proximate the center portion and creates a static magnetic field with static magnetic flux lines that form through the top and bottom portions and through a portion of the inner-most tubing string, thereby magnetizing the portion of the inner-most tubing string.

11. The tool of claim 10, wherein the top and bottom portions are each shaped as one of a disk, a revolved shape, an ovoid, and a sphere that extend radially from the center portion.

12. The tool of claim 11, wherein magnetic brushes are circumferentially positioned on an outer-most radial surface of each of the top and bottom portions.

13. The tool of claim 1, wherein the magnetizer magnetically saturates the portion of the inner-most tubing string such that the portion of the inner-most tubing string is substantially transparent to the primary and secondary magnetic fields when the magnetizer is enabled.

14. The tool of claim 13, wherein the magnetizer magnetically saturates a portion of an adjacent tubing string that is positioned radially adjacent to the inner-most tubing string such that the portion of the adjacent tubing string is substantially transparent to the primary and secondary magnetic fields when the magnetizer is enabled.

15. A method for evaluating integrity of one or more tubing strings in a wellbore, the method comprising the operations of:
positioning a logging tool with a magnetizer at a location in the wellbore;
magnetizing via the magnetizer a portion of an inner-most one of the tubing strings with a static magnetic field;
exciting the tubing strings with at least one primary electro-magnetic field created by a primary source of the logging tool;
inducing electrical eddy currents in the one or more tubing strings;
detecting via the logging tool a secondary magnetic field created by the electrical eddy currents in the one or more tubing strings with the magnetizer enabled; and
determining the integrity of the one or more tubing strings based on the detecting.

16. The method of claim 15, further comprising increasing the magnetization of the portion of the inner-most tubing string such that the portion is magnetically saturated, causing the portion to be substantially transparent to the primary and secondary fields.

17. The method of claim 16, wherein the detecting comprises producing sensed data by sensing the secondary magnetic field via at least one magnetic field sensor, and wherein the determining the integrity comprises applying an inversion algorithm to the sensed data to characterize the integrity of the one or more tubing strings.

18. The method of claim 16, further comprising:
with the magnetizer disabled and prior to the magnetizing, exciting the tubing strings with the at least one primary electromagnetic field;
inducing electrical eddy currents in the one or more tubing strings;
detecting via the logging tool the secondary magnetic field created by the electrical eddy currents in the one or more tubing strings with the magnetizer disabled; and
determining the integrity of the one or more tubing strings based on the detecting the second magnetic field with the magnetizer disabled.

19. The method of claim 18, wherein the detecting the secondary magnetic field with the magnetizer disabled comprises producing a first sensed data by sensing the secondary magnetic field via the magnetic field sensor with the magnetizer disabled, and wherein the determining the integrity of the one or more tubing strings with the magnetizer disabled comprises applying an inversion algorithm to the first sensed data to characterize the integrity of the one or more tubing strings prior to magnetizing the inner-most tubing string.

20. The method of claim 19, wherein the detecting the secondary magnetic field with the magnetizer enabled comprises producing a second sensed data by sensing the secondary magnetic field via the magnetic field sensor with the magnetizer enabled, and wherein the determining the integrity of the one or more tubing strings with the magnetizer enabled comprises applying an inversion algorithm to the second sensed data to characterize the integrity of the one or more tubing strings with the magnetizer enabled and combining the integrity characterization of the one or more tubing strings with the magnetizer disabled.

21. The method of claim 15, further comprising:
repeating the exciting, inducing, detecting, and determining operations while incrementally increasing the static magnetic field between each iteration of these operations; and
characterizing the tubing strings by applying an inversion algorithm to data acquired during the detecting after each iteration of these operations or after a last iteration of these operations.
